(19) United States
(12) Patent Application Publication
(10) Pub. No.: US 2009/0258750 A1
(43) Pub. Date: Oct. 15, 2009

(54) Vehicle differential

(76) Inventor: James F. Ziech, Kalamazoo, MI (US)

Correspondence Address: MARSHALL & MELHORN, LLC, FOUR SEAGATE, 8TH FLOOR, TOLEDO, OH, 43804, US

(21) Appl. No.: 12/082,863

(22) Filed: Apr. 15, 2008

(51) Int. Cl. F16H 48/06

(52) U.S. Cl. 475/230

(57) ABSTRACT

A differential assembly has a cross-pin connecting a ring gear to at least one section of a differential case half. The cross-pin may be secured in place by threading it into a part of the differential case or by a locking pin. Torque is transferred directly from the ring gear through the cross-pin to the differential side pinions or gears.

### FIELD OF THE INVENTION

The present invention relates to vehicle differentials.

### BACKGROUND OF THE INVENTION

Some differential cases are two piece type cases that require large and numerous bolts and nuts or substantial welding to secure the two halves together. The prior art two piece case halves also require substantial machining and labor costs to assemble them.

Regardless of whether the cases are one-piece or two pieces, hypoid or spiral bevel ring gear attachments to the differential assembly also require large and numerous bolts and nuts to secure the ring gear to the case. Substantial machining and labor costs are incurred here as well.

The joint between the ring gear and the differential case and the joint between the case halves are highly loaded and these pieces must therefore be precisely and tightly assembled to ensure that the loads in service are transferred and the joints do not become loose.

Most differentials transfer torque from the ring gear through the entire differential case then from the case to the differential spider. This load transfer is done through the above-mentioned joints that are subject to bolt loosening or weld cracking. Thus, an invention that overcomes the shortcomings of prior art briefly discussed above is needed.

### SUMMARY OF THE INVENTION

One embodiment of the present invention comprises a first differential case half and a second differential case half where the first differential case half is at least partially nested radially inward from the second differential case half. A cross-pin may be used to connect the first and second case halves together as well as to transfer torque from a ring gear to at least one differential pinion.

Another embodiment of the present invention comprises a unitary differential case having a first cross-pin aperture and a first lock-pin aperture. A unitary ring gear is also provided with a second cross-pin aperture. A cross-pin extends through both the ring gear and the differential case to transfer torque directly from the ring gear to at least one differential side pinion. A lock pin locks the cross-pin in place.

Yet another embodiment comprises a unitary ring gear and outboard differential case half. An inboard differential case half is at least partially nested within the unitary ring gear and outboard differential case half. A cross-pin extends through the combined ring gear and outboard differential case half and the inboard differential case half to secure them together. A lock-pin may be used to lock the cross-pin in place.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a partial cross-sectional plan view of one embodiment of the present invention;

FIG. 2 is partial cross-sectional plan view of another embodiment of the present invention wherein half of a cross-pin, differential and axle half shafts are depicted, the other halves being substantially identical to the halves shown;

FIG. 3 is partial cross-sectional plan view of another embodiment of the present invention wherein half of a cross-pin, differential and axle half shafts are depicted, the other halves being substantially identical to the halves shown.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

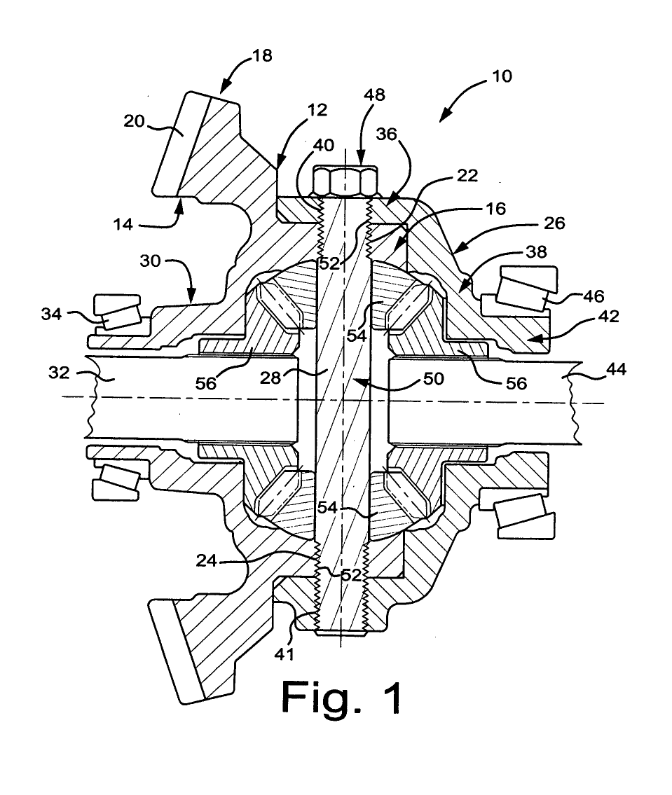

FIG. 1 depicts a portion of one embodiment of a differential assembly 10. The differential assembly 10 comprises a first differential case half 12 having a unitary inboard portion 14 and outboard portion 16. The inboard portion 14 comprises a ring gear 18 at a radially outermost position. The ring gear 18 has a plurality of teeth 20 for engaging with a pinion gear (not shown). The outboard portion 16 of the first differential case half 12 has a first cross-pin aperture 22. The aperture 22 has a first set of threads 24 therein.

In the shown preferred embodiment, the ring gear 18, and more specifically the plurality of teeth 20 on the ring gear 18, is positioned on the inboard portion 14 of the first differential case half 12 such that the teeth 20 are located entirely inboard of a second differential case half 26 (described below). The ring gear teeth 20 are also preferably located inboard of a cross-pin 28 (described below) such that the two do not radially overlap one another.

The inboard portion 14 of the first differential case half 12 has a radially inward depending shoulder 30 that extends about a first axle half shaft 32. Typically, a bearing 34 is provided adjacent the shoulder 30 to facilitate rotation of the first differential case half 12 with respect to the differential housing (not shown).

The assembly 10 also comprises the second differential case half 26 having unitary inboard portion 36 and outboard portions 38. The outboard portion 16 of the first differential case half 12 is nested radially inward under the inboard portion 36 of the second differential case half 26. The inboard portion 36 of the second differential case half 26 has a second cross-pin aperture 40. The second cross-pin aperture 40 may be threaded with threads 41. It is also radially aligned with the first cross-pin aperture 22 of the first differential case half 12.

The outboard portion 38 of the second differential case half 26 has a radially inward depending shoulder 42 that extends about a second axle half shaft 44. Typically, a bearing 46 is provided adjacent the shoulder 42 to facilitate rotation of the second differential case half 26 with respect to the differential housing (not shown).

Preferably, the outboard portion 16 of the first differential case half 12 extends axially outward beyond the first and second apertures 22, 40. It is also preferred that the inboard portion 36 of the second differential case half 26 extends axially inward beyond the first and second apertures 22, 40.

The cross-pin 28 has a head portion 48 and a body portion 50. The body portion 50 has second set of threads 52 for threadably engaging with the first set of threads 24 of the second cross-pin aperture 40 of the inboard portion 36 of the second differential case half 26. Threads 41 may also be engaged. Preferably, the head 48 of the cross-pin 28 is located adjacent the inboard portion 36 of the second differential case half 26. In the depicted embodiment, the head portion 48 of the cross-pin 28 rests directly radially outward on the inboard portion 36 of the second differential case half 26.

Preferably, the cross-pin 28 extends through the inboard portion 36 of the second differential case half 26, through the outboard portion 16 of the first differential case half 12 and between the first axle half shaft 32 and the second axle half shaft 44.

It is within the scope of the present invention to utilize two cross-pins transverse to one another in the differential assembly 10, depicted in FIG. 1.

At least one side pinion and at least one side gear are nested radially inward from the first differential case half 12 and the second differential case half 26. In the depicted embodiment, two side pinions 54 and two side gears 56 are shown. The side pinions 54 are meshed in driving engagement with the side gears 56 and the side gears 56 are splined to the axle half shafts 32, 44.

Based on the foregoing, it can be appreciated that the ring gear 18 can transfer torque directly to the cross pin 28. It can also be appreciated that the cross-pin 28 functions both as the driving member for the side pinions 54 and the side gears 56 and it functions as the locking device that secures the first and second differential case halves 12, 26 together. The gear reaction forces are transferred from the ring gear 18 through the differential case 12, 26 to the taper bearings 34 and 46.

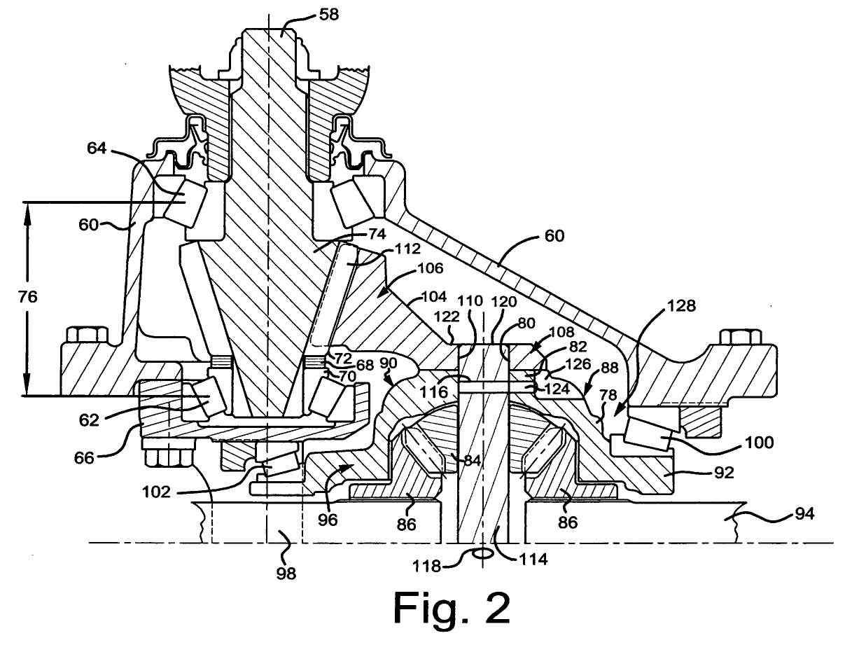

Looking now at FIG. 2, a second embodiment of the present invention is depicted. FIG. 2 shows additional structure in which the differential assembly 10 of FIG. 1 may operate. The other half of the differential and axle half shafts of FIG. 2 can be appreciated from FIG. 1.

For example, FIG. 2 depicts a pinion shaft 58 rotatably mounted within a differential housing 60. An inner pinion bearing 62 and an outer pinion bearing 64, both located in bearing races, may be located between the pinion shaft 58 and the housing 60. The inner pinion bearing 62 may be supported by a pedestal 66. The pedestal 66 may be unitary with the housing 60 or it may be bolted on.

A spacer 68 may be located between an inner race 70 of the inner pinion bearing 62 and the plurality of teeth 72 of a pinion gear 74 formed on the pinion shaft 58. The spacer 68 provides a predetermined distance 76 between the inner pinion bearing 62 and the outer pinion bearing 64 so that the pinion bearings 62, 64 have a predetermined preload.

A unitary differential case 78 is provided having a first cross-pin aperture 80 and a first lock-pin aperture 82 that is oriented transversely to the first cross-pin aperture 80. The differential case 78 substantially entirely encloses two side pinions 84 and two side gears 86.

The differential case 78 has an outboard portion 88 and an inboard portion 90. The outboard portion 88 has a downwardly depending shoulder 92 that extends about an axle half shaft 94. The inboard portion 90 has a downwardly depending shoulder 96 that extends about another axle half shaft 98.

A bearing 100 is provided between the shoulder 92 of the outboard portion 88 and the differential housing 60. Similarly, another bearing 102 is provided between the shoulder 96 of the inboard portion 90 and the pedestal 66. Both bearings 100, 102 function to facilitate rotation of the differential case 78 within the differential housing 60.

Preferably, as seen in FIG. 2, the differential case 78 is at least partially nested radially inward within a ring gear 104. While the entire differential case 78 is radially inward, the downwardly depending shoulder 92 of the outboard portion 88 is not nested within the ring gear 104.

The ring gear 104 is a unitary, one-piece structure having an inboard portion 106 and an outboard portion 108. The outboard portion 108 defines a second cross-pin aperture 110. The second cross-pin aperture 110 is aligned with the first cross-pin aperture 80. The outboard portion 108 of the ring gear 104 defines a plurality of teeth 112 designed to engage with the teeth 72 on the pinion gear 74.

A cross-pin 114 extends through the first cross-pin aperture 80 and the second cross-pin aperture 110. The cross-pin 114 also supports the at least two side pinions 84 thereon. The cross-pin 114, which is unitary and one-piece, extends between the two axle half shafts 94, 98. The cross-pin 114 has a second lock-pin aperture 116 extending through a radially outward portion of the cross-pin 114. The lock-pin apertures 82, 116 extend transverse to the axis 118 of the cross-pin 114.

The cross-pin 114 extends radially outward through the outboard portion 108 of the ring gear 104. The cross-pin 114 has an upper surface 120 that is substantially radially equal to an upper surface 122 of the outboard portion 108 of the ring gear 104.

The inboard portion 106, bearing the teeth 112, of the ring gear 104 does not radially overlap the cross-pin 114. The outboard portion 108 of the ring gear 104, however, does extend axially outboard beyond the cross-pin aperture 110.

A lock pin 124 is removably located in both the first lock-pin aperture 82 and the second lock-pin aperture 116. The lock-pin 124 extends substantially transverse to the cross-pin axis 118. The lock-pin 124 is accessed through a depression 126 in an outboard portion 128 of the differential case 78.

Based on the foregoing, it can be appreciated that torque from the pinion gear 74 is transferred directly to the ring gear 104 which transfers the torque directly to the cross-pin 114. The cross-pin 114 transfers the torque directly to the differential pinions 84.

It is within the scope of the present invention to utilize two cross-pins transverse to one another in the differential assembly depicted in FIG. 2.

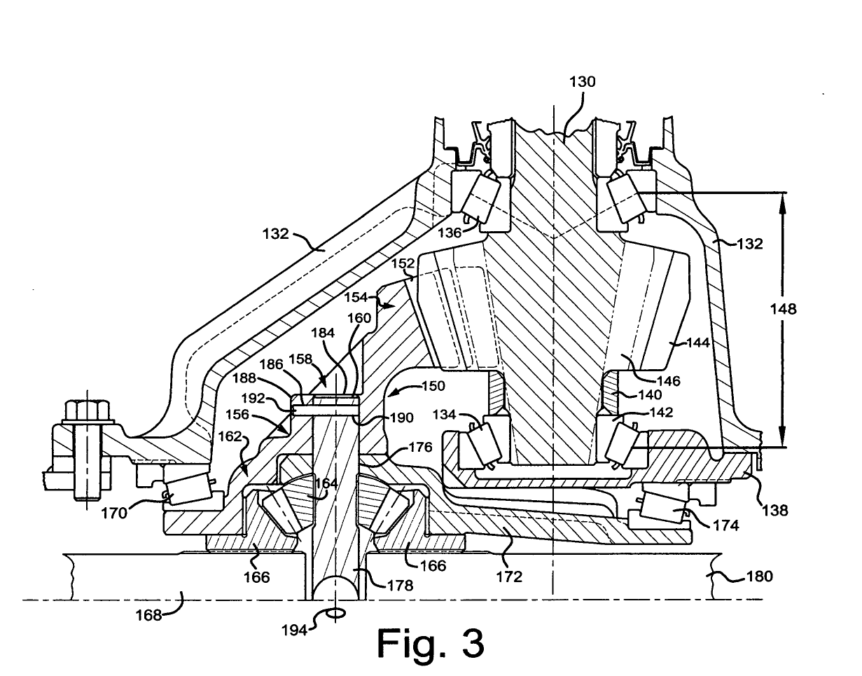

Looking now at FIG. 3, another embodiment of the present invention is depicted. FIG. 3 shows additional structure in which the differential assembly 10 of FIG. 1 may operate. The other half of the differential and axle half shafts of FIG. 3 can be appreciated from FIG. 1.

For example, FIG. 3 depicts a pinion shaft 130 rotatably mounted within a differential housing 132. An inner pinion bearing 134 and an outer pinion bearing 136, both located in bearing races, may be located between the pinion shaft 130 and the housing 132. The inner pinion bearing 134 may be supported by a pedestal 138. The pedestal 138 may be unitary with the housing 132 or it may be bolted on.

A spacer 140 may be located between an inner race 142 of the inner pinion bearing 134 and a plurality of teeth 144 of a pinion gear 146 formed on the pinion shaft 130. The spacer 140 provides a predetermined distance 148 between the inner pinion bearing 134 and the outer pinion bearing 136 so that the pinion bearings 134, 136 have a predetermined preload.

A combined unitary ring gear and outboard differential case half 150 is provided. The ring gear portion 154 has a plurality of teeth 152 designed to engage with the teeth 144 of the pinion gear 146. The ring gear portion 154 extends inwardly toward the pinion gear 146 from the outboard differential case half portion 156.

Outboard from the ring gear portion 154, a flat 158 is provided in the combined ring gear and outboard differential case half 150. The flat 158 contains a first cross-pin aperture 160. Outboard from the first cross-pin aperture 160, the outboard differential case half portion 156 comprises a downwardly depending shoulder 162. The shoulder 162 covers part of at least one differential side pinion 164 as well as one of the differential side gears 166. The shoulder 162 extends downwardly toward a first axle half shaft 168. A bearing 170 is located between the shoulder 162 and the differential housing 132 to permit rotation of at least the outboard differential case half portion 156 with respect to the housing 132.

An inboard differential case half 172 is also provided. The inboard differential case half 172 is nested within and located substantially radially inward from the majority of the combined ring gear and outboard differential case half 150; it is located entirely radially inward from the ring gear portion 154 of the combined ring gear and outboard differential case half 150. The inboard differential case half 172 extends inwardly adjacent the pinion shaft 130. A bearing 174, is located between the inboard differential case half 172 and the pedestal 138 to permit rotation of the differential case halves 156, 172 with respect to the pedestal 138 and housing 132.

The inboard differential case half 172 has a second cross-pin aperture 176. The inboard differential case half 172 extends in an outboard direction beyond the second cross-pin aperture 176. The inboard differential case half 172 extends over the differential side pinions 164 and an inboard side gear 166.

A cross-pin 178 extends through the first cross-pin aperture 160 in the combined ring gear and outboard differential case half 150 and the second cross-pin aperture 176 in the inboard differential case half 172 and between the first axle half shaft 168 and a second axle half shaft 180. As such, it can be appreciated that the apertures 160, 176 are radially aligned with one another. Based on FIG. 3, it can also be appreciated that the ring gear teeth 152 are entirely located inboard from the cross-pin 178.

The cross-pin 178 has an upper outermost radial surface 184 that is substantially radially even with the flat 158 in the outboard differential case half portion 156.

A first lock-pin aperture 186 is provided in an outboard surface 188 of the outboard differential case half portion 156. A second lock-pin aperture 190 is provided in a radially outer portion of the cross-pin 178. The lock-pin apertures 186, 190 align with one another so that a lock-pin 192 can be removably located therethrough. The apertures 186, 190 and the lock-pin 192 are oriented substantially transversely to an axis 194 of the cross-pin 178.

It is within the scope of the present invention to utilize two cross-pins transverse to one another in the differential assembly depicted in FIG. 3.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A differential, comprising:
a first differential case half having unitary inboard and outboard portions, said inboard portion having a unitary ring gear and said outboard portion having a first cross-pin aperture;
a second differential case half having unitary inboard and outboard portions, wherein said outboard portion of said first differential case half is nested under said inboard portion of said second differential case half, said inboard portion of said second differential case half having a second cross-pin aperture that is threaded and aligned with said first cross-pin aperture of said first differential case half, wherein said outboard portion of said first differential case half extends outwardly beyond said first and said second cross-pin apertures and said inboard portion of said second differential case half extends inwardly beyond said first and second cross-pin apertures; and
a cross-pin having a head portion and a body portion, said body portion having a set of threads for engaging with said second cross-pin aperture threads, said head portion being located adjacent said inboard portion of said second differential case half.

2. The differential of claim 1, wherein said ring gear is positioned inboard of said second differential case half.

3. The differential of claim 1, wherein said inboard portion of said first differential case half has a radially inward depending shoulder that extends about a first axle half shaft.

4. The differential of claim 1, wherein said outboard portion of said second differential case half has a radially inward depending shoulder that extends about a second axle half shaft.

5. The differential of claim 1, wherein said head portion of said cross-pin rests directly radially outward on said inboard portion of said second differential case half.

6. The differential of claim 1, wherein said cross pin extends through said inboard portion of said second differential case half, through said outboard portion of said first differential case half and between said first axle half shaft and said second axle half shaft.

7. The differential of claim 1, wherein said ring gear is located inboard of said cross-pin such that the two do not radially overlap one another.

8. A differential, comprising:
a unitary differential case having a first cross-pin aperture and a first lock-pin aperture transverse to said first cross-pin aperture, said differential case substantially enclosing two side pinions and two side gears;
a unitary ring gear having an inboard portion and an outboard portion, said outboard portion defining a second cross-pin aperture that is aligned with said first cross-pin aperture, said outboard portion defining a plurality of teeth;
a cross-pin extending through said first cross-pin aperture and said second cross-pin aperture, said cross-pin having a second lock pin aperture; and
a lock pin located in both said first lock-pin aperture and said second lock-pin aperture.

9. The differential of claim 8, wherein said inboard portion of said ring gear does not radially overlap said cross-pin.

10. The differential of claim 1, wherein said cross-pin extends through said outboard portion of said ring gear, through said differential case and between a first axle half shaft and a second axle half shaft.

11. The differential of claim 1, wherein said lock-pin aperture is located on an outboard portion of said differential case.

12. The differential of claim 1, wherein said cross-pin has an upper surface that is substantially radially equal to an upper surface of said outboard portion of said ring gear.

13. The differential of claim 1, wherein said outboard portion of said ring gear extends axially outboard beyond said cross-pin aperture

14. The differential of claim 1, wherein said differential case has an outboard portion and an inboard portion, wherein said outboard portion has a downwardly depending shoulder that extends about said second axle half shaft and said inboard portion has a downwardly depending shoulder that extends about said first axle half shaft.

15. The differential of claim 1, wherein said differential case is at least partially nested radially inward within said ring gear.

16. A differential, comprising:
a combined unitary ring gear and outboard differential case half;
an inboard differential case half nested in and located radially inward from said combined ring gear and outboard differential case half; and
a cross-pin extending through said combined ring gear and outboard differential case half, said inboard differential case half and a first and a second axle half shaft;
wherein ring gear teeth of said combined ring gear and outboard differential case half are located inboard from said cross-pin and wherein said inboard differential case half extends axially outboard from said cross-pin.

17. The differential of claim 1, wherein a cross-pin aperture extends through said combined ring gear and outboard differential case half and a cross-pin aperture extends through said inboard differential case half, said apertures being aligned with one another.

18. The differential of claim 1, wherein a lock-pin aperture is located transverse to said cross-pin aperture in said combined ring gear and outboard differential case half, said lock-pin aperture located in an outboard surface of said combined ring gear and outboard differential case half.

19. The differential of claim 1, wherein a lock-pin is selectively located in said lock-pin aperture to engage said cross-pin.

20. A differential, comprising:
a pinion gear having a plurality of teeth rotatingly mounted between an inner pinion bearing and an outer pinion bearing, said inner pinion bearing having an inner race abutting said pinion gear and an outer race supported by a pedestal that is secured to a differential housing;
a spacer abutting both said inner race of said inner pinion bearing and said teeth of said pinion gear;
a cross-pin connecting said ring gear to at least one section of a differential case half, said cross-pin secured in place by a locking pin extending through said at least one section of differential case half, said locking pin oriented transverse to said cross-pin; and
a ring gear having a plurality of teeth engaged with said plurality of teeth of said pinion gear, said cross-pin extending through a least a portion of said ring gear;
wherein said cross-pin is offset axially outboard from said plurality of teeth of said ring gear.

21. The differential of claim 20, wherein said spacer provides a predetermined distance between said inner pinion bearing and said outer pinion bearing so that said pinion bearings have a predetermined preload.
